(19) United States
(12) Patent Application Publication
(10) Pub. No.: US 2006/0086448 A1
(43) Pub. Date: Apr. 27, 2006

(54) Liquid crystal component

(75) Inventors: Emile Johannes Karel Verstegen, Eindhoven (NL); Hendrik Roelof Stapert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINIKJKLE PHILLIPS ELECTRONICS N.V.

(21) Appl. No.: 10/540,684

(22) PCT Filed: Dec. 16, 2003
(86) PCT No.: PCT/IB03/06040

§ 371 Date: Jun. 24, 2005

(30) Foreign Application Priority Data
Dec. 30, 2002 (EP) 02080550.3

(51) Int. Cl. B29D 11/00

(52) U.S. Cl. 156/60; 264/1.7

(57) ABSTRACT

A method of manufacturing a component comprising liquid crystal is described. The method comprises placing a liquid crystal (200) between a substrate (150) and a mould (100), the mould (100) having a shaped surface (102). At least a portion of the shaped surface (102) has an alignment layer (110) formed on it. The substrate (150) has a first surface (152) on which is formed a bonding layer (120). Mould and substrate are brought together so as to sandwich liquid crystal between the first surface of the substrate and the shaped surface of the mould. The liquid crystal (202) is polymerised and thereby adhered to the bonding layer (120). The substrate (150) with the adhered polymerised liquid crystal (203) is removed from the mould (100).

### FIELD OF THE INVENTION

The present invention relates to a method of manufacturing a component comprising liquid crystal, a component comprising liquid crystal manufactured according to the method, and devices including such components. The method is particularly suitable for, but not limited to, manufacturing liquid crystal lenses for use in optical scanning devices.

### BACKGROUND OF THE INVENTION

Optical pickup units for use in optical scanning devices are known. The optical pickup units are mounted on a movable support for scanning across the tracks of the optical disk. The size and complexity of the optical pickup unit is preferably reduced as much as practicable, in order to reduce the manufacturing cost and to allow additional space for other components being mounted in the scanning device.

Modern optical pickup units are generally compatible with at least two different formats of optical disk, such as the Compact Disc (CD) and the Digital Versatile Disc (DVD) format. Recently proposed has been the Blu-ray Disk (BD) format, offering a data storage capacity of around 25 GB (compared with a 650 MB capacity of a CD, and a 4.7 GB capacity of a DVD).

Larger capacity storage is enabled by using small scanning wavelengths and large numerical apertures (NA), to provide small focal spots, (the size of the focal spot is approximately λ/NA), so as to allow the readout of smaller sized marks in the information layer of the disk. For instance, a typical CD format utilizes a wavelength of 785 nm and an objective lens with a numerical aperture of 0.45, a DVD uses a wavelength of 650 nm and a numerical aperture of 0.65, and a BD system uses a wavelength of 405 nm and a numerical aperture of 0.85.

Typically, the refractive index of materials vary as a function of wavelength. Consequently, a lens will provide different focal points and different performance for different incident wavelengths. Further, the discs may have different thickness transparent layers, thus requiring a different focal point for different types of discs.

In some instances, storage capacity is further increased by increasing the number of information layers per disc. For example, a dual layer BD-disc has two information layers separated by a 25 μm thick spacer layer. Thus, the light from the optical pickup unit has to travel through the spacer layer when focusing on the second information layer. This introduces 255 mλ rms (0.255λ root mean square) spherical aberration, the phenomenon that rays close to the axis of the converging cone of light have a different focal point compared to the rays on the outside of the cone. This results in a blurring of the focal spot, and a subsequent loss of fidelity in the read-out of the disc.

To enable dual layer readout and backward compatibility (i.e. the same optical system being used for different disc formats), polarization sensitive lenses (PS-Lenses) have been proposed to compensate for spherical aberration. Such lenses can be formed of a birefringent material, such as a liquid crystal. Birefringence denotes the presence of different refractive indices for the two polarization components of a beam of light. Birefringent materials have an extraordinary refractive index (nₑ) and an ordinary refractive index (nₒ), with the difference between the refractive indices being Δnₑ−nₒ. PS lenses can be used to provide different focal points for a single or different wavelength(s) by ensuring that the same or different wavelengths are incident upon the lens with different polarisations.

In order to form the lens with the desired optical properties, the liquid crystal molecules need to be directed in a specific orientation. Well known materials to induce this orientation are polyimides. These polyimides are usually applied via spincoating, and subsequently rubbed with a non-fluff cloth to induce a specific orientation of the polyimide alignment layer, which subsequently determines the orientation of the liquid crystal molecules placed upon the layer.

However, if a substrate on which the liquid crystal molecules have to be oriented is curved (or otherwise shaped e.g. with a step structure) rubbing of the substrates is often irreproducible. Further, creating suitably shaped substrates with a specific desired curvature is relatively expensive.

JP 031578616A describes a method of manufacturing a liquid crystal lens by laminating transparent polycarbonate sheets via adhesive agent on both surfaces of a flat plate of variable focus liquid crystal, and subsequently pressing the sheet by moulds, so as to obtain the desired shape of liquid crystal lens. Such a process requires that the flat plate liquid crystal layer has been previously aligned prior to lamination. Further, it is likely that the subsequent molding of the liquid crystal will act to alter the alignment of the liquid crystal within the lens body. In some instances, it may also be desirable to subsequently remove the transparent polycarbonate sheets, requiring an additional processing step and potentially resulting in the lens surface being damaged.

It is an aim of embodiments of the present invention to provide an improved manufacturing process which addresses one or more of the problems of the prior art, whether referred to herein or otherwise.

It is an aim of embodiments of the present invention to provide a manufacturing process that allows the formation of a component comprising liquid crystal having a predetermined shape that can be relatively cheaply manufactured, as well as liquid crystal components formed by such a method.

### STATEMENTS OF THE INVENTION

In a first aspect, the present invention provides a method of manufacturing a component comprising liquid crystal, the method comprising: placing a liquid crystal between a substrate and a mould, the mould having a shaped surface, at least a portion of the shaped surface having an alignment layer formed thereon, and the substrate having a first surface on which is formed a bonding layer; bringing the mould and the substrate together so as to sandwich the liquid crystal between the first surface of the substrate and the shaped surface of the mould; polymerising the liquid crystal; adhering the liquid crystal to the bonding layer; and removing the substrate with the adhered polymerised liquid crystal from the mould.

Such a manufacturing method allows the predetermined shaped mould to be reused. This decreases the cost of the manufacturing process. Further, as the alignment layer within the mould can also be reused, reproducibility of the orientation and shape of components formed by the process is improved.

In another aspect, the present invention provides an optical component comprising a liquid crystal, at least a portion of the optical component being formed according to the method as described above.

In a further aspect, the present invention provides an optical scanning device for scanning an information layer of an optical record carrier, the device comprising a radiation source for generating a radiation beam and an objective system for converging the radiation beam on the information layer, wherein the device comprises an optical component formed according to the method as described above.

### BRIEF DESCRIPTION OF DRAWINGS

For a better understanding of the invention, and to show how embodiments of the same may be carried into effect, reference will now be made, by way of example, to the accompanying diagrammatic drawings in which:

FIGS. 1A-1F illustrate method steps in the formation of a liquid crystal lens in accordance with a preferred embodiment of the present invention;

FIG. 2 illustrates a cross sectional view of a mould as may be used in the method shown in FIG. 1;

FIG. 3 illustrates a device for scanning an optical record carrier including a liquid crystal lens in accordance with an embodiment of the present invention; and

FIGS. 4A and 4B illustrate how the optical system of the scanning device shown in FIG. 3 may be used with different polarisations of light to scan different layers within a dual layer optical record carrier.

### DETAILED DESCRIPTION OF PREFERRED EMBODIMENTS

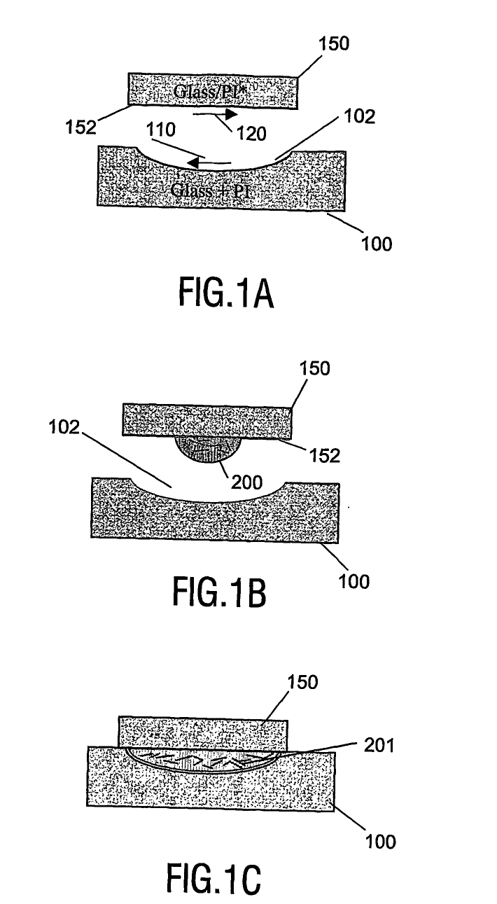

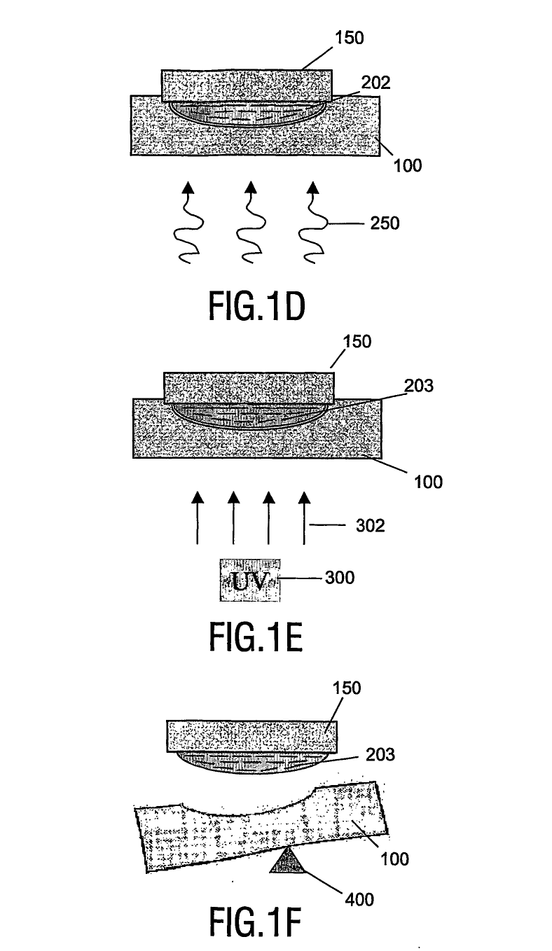

FIGS. 1A-1F illustrate respective steps in forming an optical component in accordance with a preferred embodiment of the present invention. In this particular instance, the optical component is a liquid crystal birefringent lens.

In the first step, shown in FIG. 1A, mould 100 is provided, the mould having a shaped surface 102 which subsequently serves to define a portion of the shape of the resulting optical component. In this particular instance, the liquid crystal is ultimately photopolymerised, and consequently the mould is formed of a material transparent to the radiation used to polymerize the liquid crystal e.g. glass, plastic.

An alignment layer 110 is arranged on the curved surface 102, so as to induce a predetermined orientation (indicated by the arrow direction 110) in the liquid crystal subsequently placed upon the alignment layer.

In this particular example, the alignment layer is a layer of polyimide (PI). The polyimide may be applied using spincoating from a solution. The polyimide may then be aligned so as to induce a specific orientation (this orientation determining the resulting orientation of the liquid crystal molecules). For instance, a known process is to rub the polyimide layer with a non-fluff cloth repeatedly in a single direction so as to induce this orientation (110).

A substrate 150, which in this particular embodiment will form part of the optical component, has a bonding layer 120 applied to a first surface 152. The bonding layer is arranged to form a bond with the liquid crystal. In this particular instance, the bonding layer is also an alignment (or orientation) layer comprising polyimide. The bonding layer contains reactive groups arranged to form a chemical bond with the liquid crystal molecules, and in this instance has the same type of reactive group as the liquid crystal molecules, such that when photopolymerising the liquid crystal molecules, chemical bonds with the bonding layer on the substrate are also created. This results in very good adhesion between substrate and the liquid crystal layer. The bonding layer may be deposited on the substrate using the same type of process used to deposit and align the alignment layer on the mould 100. The bonding layer, which in this instance also functions as an alignment layer, is oriented in a predetermined orientation (arrow 120) depending upon the desired properties of the resulting liquid crystal components.

In this particular example, a PS lens is being formed, so the bonding layer is aligned so as to be parallel to the direction 110 of the alignment layer on the mould. Preferably, the rotation of the bonding layer is parallel but in the opposite direction to the orientation of the alignment layer.

As illustrated in FIG. 1B, a compound 200 incorporating one or more liquid crystals is then placed between the first surface 152 of the substrate 150 and the shaped surface 102 of the mould 100.

In this particular example, as illustrated in FIG. 1B, the compound 200 comprises a mixture of two different liquid crystals. These two different liquid crystals have been chosen so as to provide the desired refractive index properties once at least one of the liquid crystals has been polymerized.

A droplet of the liquid crystals 200 is placed on the first surface 152 of the substrate. The compound 200 has been degassed, so as to avoid the inclusion of air bubbles within the resulting optical component. It also avoids the formation of air bubbles from dissolved gases coming out of the solidifying liquid during (isochorous) polymerization, as the driving force from shrinkage during isochorous (i.e. constant volume) polymerization leads to a large pressure drop inside the polymerizing liquid.

The glass mould is then heated so that the liquid crystal is in the isotropic phase (typically to about 80° C.-120° C.), so as to facilitate the subsequent flow of the liquid crystal into the desired shape.

The substrate and the mould are subsequently brought together, so as to define the shape of the liquid crystal portion 201 of the final resulting optical component (FIG. 1C). In order to ensure that the liquid crystal forms a homogenous layer between the mould and the substrate, a pressure may be applied to push the substrate towards the mould (or vice versa).

The substrate/mould/liquid crystal may then be cooled, for instance down to room temperature for 30 minutes, so as to ensure that the liquid crystal enters the nematic phase, coming from the isotropic phase.

When entering the nematic stage, multi domains may appear in the liquid crystal mixture. Consequently, the mixture can be heated to above the clearing point to destroy the multidomain orientation (e.g. the mixture may be heated for 3 minutes to 105° C.). Subsequently, the mixture may be cooled to obtain a homogenous orientation 202 (FIG. 1D).

The homogenous liquid crystal mixture may then be photopolymerised using light 302 from an ultra violet radiation source 300 (FIG. 1E), for instance by applying a UV-light intensity of 10 mW/cm² for 60 seconds. At the same time, chemical bonds will be formed between the liquid crystal and the bonding layer.

Subsequently, the optical component (150, 203) can be released from the mould 100 (FIG. 1F). This could, for instance, be achieved by slightly bending the mould 100 over a cornered object 400. Alternatively, it could be achieved by pressing a portion of the flat substrate in a flat support, so as to slightly bend the flat substrate. The liquid crystal/substrate component should separate easily from the mould, when a conventional polyimide (without reactive groups) was used on the mould.

The mould can be reused to produce subsequent components, by repeating steps illustrated in FIGS. 1B-1F. Typically, the alignment layer will remain upon the mould 100, and hence does not need to be reapplied.

If desired, a further processing step can be performed to remove the liquid crystal 203 from the substrate 150. However, in most instances it is assumed that the substrate 150 will form part of the final optical component.

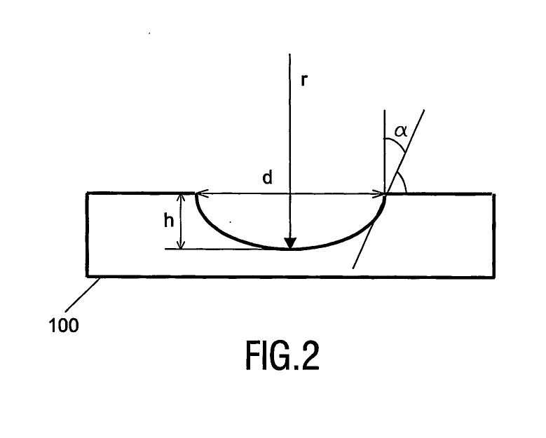

In experiments to characterize the influence of the mould parameters on the optical properties of the lenses, three different shaped moulds were utilized. FIG. 2 illustrates the parameters that were varied for the three different shaped moulds, where r=curvature radius, d=diameter, h=height and α=angle between the tangent and mould surface. Table 1 illustrates the different parameters associated with the three different moulds.

TABLE 1

| r (mm) | d (mm) | h (mm) | α (°) |
|---|---|---|---|
| 100 | 3.36 | 0.014 | 0.96 |
| 49 | 3.44 | 0.030 | 1.97 |
| 21 | 3.84 | 0.088 | 5.50 |

A suitable polyimide for use in the alignment layer is OPTMER AL-1051 supplied by Japan Synthetic Rubber Co., whilst Merck ZLI2650, spincoated from a solution in γ-butyrolactone can be used as an appropriate reactive polyimide with methacrylate groups as the bonding layer.

As mentioned above, in the preferred embodiment a mixture of two liquid crystals was utilized to obtain the desired nₑ and nₒ. The two liquid crystals utilized were 1,4-di(4-(3-acryloyloxypropyloxy)benzoyloxy)-2-methylbenzene (RM 257) and E7 (a cyanobiphenyl mixture with a small portion of cyanotriphenyl compound) both from Merck, Darmstadt, Germany. The photoinitiator used to ensure the photo polymerization of the liquid crystals was Irgacure 651, obtainable from Ciba Geigy, Basel.

Resulting measurements illustrated that the lenses made from the mould with the radius of 49 mm had the best optical properties, with a very homogenous liquid crystal orientation even in the region near the pupil boarders where the mould surface is steeper. The total root mean square wavefront aberration was generally less than 0.015 wavelengths, using a laser wavelength of 430 nm.

In some instances, a surfactant was mixed with the liquid crystal to promote the lens release from the mould. The surfactants utilized were FC171 a perfluorinated surfactant (3M) and 2-(N-ethylperfluorooctane sulfonamido-ethylacrylate (Acros). The use of the surfactant was seen to influence the orientation of the liquid crystal (a lower Δn was seen when a surfactant was utilised).

In general, the optical aberrations of the liquid crystal lenses were very small, and generally the root mean square wavefront aberration was less than 0.02 wavelengths.

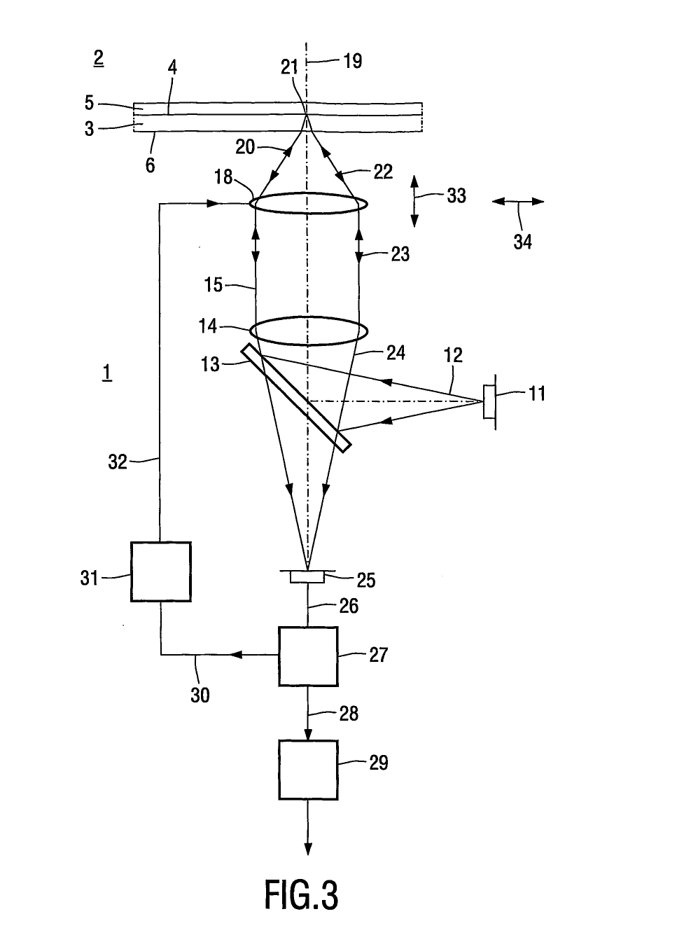

FIG. 3 shows a device 1 for scanning an optical record carrier 2, including an objective lens 18 according to an embodiment of the present invention. The record carrier comprises a transparent layer 3, on one side of which an information layer 4 is arranged. The side of the information layer facing away from the transparent layer is protected from environmental influences by a protection layer 5. The side of the transparent layer facing the device is called the entrance face 6. The transparent layer 3 acts as a substrate for the record carrier by providing mechanical support for the information layer.

Alternatively, the transparent layer may have the sole function of protecting the information layer, while the mechanical support is provided by a layer on the other side of the information layer, for instance by the protection layer 5 or by a further information layer and a transparent layer connected to the information layer 4. Information may be stored in the information layer 4 of the record carrier in the form of optically detectable marks arranged in substantially parallel, concentric or spiral tracks, not indicated in the Figure. The marks may be in any optically readable form, e.g. in the form of pits, or areas with a reflection coefficient or a direction of magnetization different from their surroundings, or a combination of these forms.

The scanning device 1 comprises a radiation source 11 that can emit a radiation beam 12. The radiation source may be a semiconductor laser. A beam splitter 13 reflects the diverging radiation beam 12 towards a collimator lens 14, which converts the diverging beam 12 into a collimated beam 15. The collimated beam 15 is incident on an objective system 18.

The objective system may comprise one or more lenses and/or a grating. The objective system 18 has an optical axis 19. The objective system 18 changes the beam 17 to a converging beam 20, incident on the entrance face 6 of the record carrier 2. The objective system has a spherical aberration correction adapted for passage of the radiation beam through the thickness of the transparent layer 3. The converging beam 20 forms a spot 21 on the information layer 4. Radiation reflected by the information layer 4 forms a diverging beam 22, transformed into a substantially collimated beam 23 by the objective system 18 and subsequently into a converging beam 24 by the collimator lens 14. The beam splitter 13 separates the forward and reflected beams by transmitting at least part of the converging beam 24 towards a detection system 25. The detection system captures the radiation and converts it into electrical output signals 26. A signal processor 27 converts these output signals to various other signals.

One of the signals is an information signal 28, the value of which represents information read from the information layer 4. The information signal is processed by an information processing unit for error correction 29. Other signals from the signal processor 27 are the focus error signal and radial error signal 30. The focus error signal represents the axial difference in height between the spot 21 and the information layer 4. The radial error signal represents the distance in the plane of the information layer 4 between the spot 21 and the center of a track in the information layer to be followed by the spot.

The focus error signal and the radial error signal are fed into a servo circuit 31, which converts these signals to servo control signals 32 for controlling a focus actuator and a radial actuator respectively. The actuators are not shown in the Figure. The focus actuator controls the position of the objective system 18 in the focus direction 33, thereby controlling the actual position of the spot 21 such that it coincides substantially with the plane of the information layer 4. The radial actuator controls the position of the objective lens 18 in a radial direction 34, thereby controlling the radial position of the spot 21 such that it coincides substantially with the central line of track to be followed in the information layer 4. The tracks in the Figure run in a direction perpendicular to the plane of the Figure.

The device of FIG. 3 in this particular embodiment is adapted to scan also a second type of record carrier having a thicker transparent layer than the record carrier 2. The device may use the radiation beam 12 or a radiation beam having a different wavelength for scanning the record carrier of the second type. The NA of this radiation beam may be adapted to the type of record carrier. The spherical aberration compensation of the objective system must be adapted accordingly.

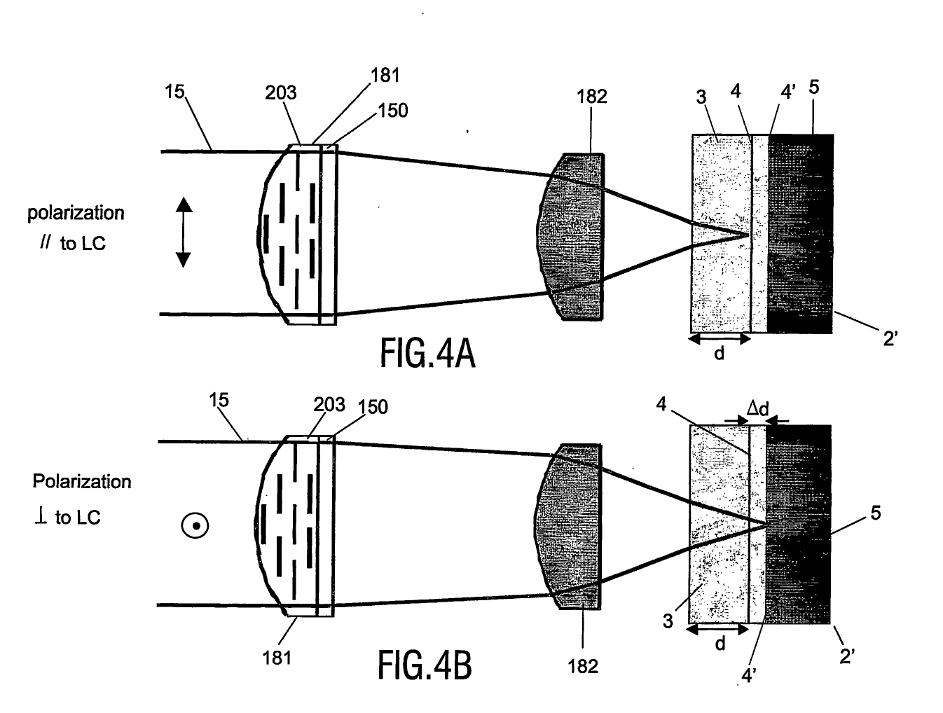

FIGS. 4A and 4B illustrate how the polarization sensitive lens manufactured in accordance with the above embodiment can be utilised to provide two different focal points, suitable for reading a dual-layer optical recording medium 2′. The dual-layer medium 2′ has two information layers (4, 4′) a first information layer 4 at a depth d within the transparent layer 3, and a second information 4′ a further distance Δd beneath the first information layer 4.

In the embodiment shown in FIGS. 4A and 4B, the objective system comprises a polarization sensitive lens 181 (comprising liquid crystal 203, and manufactured as described above), and a second lens 182.

The focal point of the objective system can be altered by using the bifocal nature of the liquid crystal lens 181. In this particular instance, the substrate 150 used in the lens manufacture is glass. Further, the substrate is a planar sheet, and as such does not effect the focusing power of the lens. The focal length of the lens 181 is thus fₑ=r/(nₑ−nₐ) and f₀=r/(nₒ−nₐ) for the extraordinary and ordinary modes respectively, where nₐ is the refractive index of air, and r is the curvature radius of the lens.

Consequently, it will be seen that by providing an optical signal with polarization parallel to the liquid crystal orientation, such that the extraordinary mode of the lens 181 is utilised, the objective system 18 will focus the collimated beam 15 on the nearer information layer 4. However, when the collimated beam is incident on to the objective system 18 with polarisation perpendicular to the liquid crystal orientation, in the resulting ordinary mode the focal point of the objective system 18 is further away i.e. on the second information layer 4′.

It will be appreciated that the above embodiments are described by way of example only, and that various alternatives will be apparent to the skilled person. For instance, whilst a method has been described suitable for producing polarisation sensitive lenses, it will be appreciated that any optical component can be manufactured from liquid crystal as desired, particularly if the resulting optical component has a shaped surface such as that might be defined by a curved surface or a step surface on a mould.

For instance, the method could be used to form components having large surfaces, such as compensation foils that can be used in or on the surface of visual displays for viewing angle optimization. In such a compensation foil, the display screen itself could be used as the substrate in the manufacturing method.

The mould may be formed of any material, including rigid materials such as glass.

Further, the shaped surface of the mould may be dimensioned so as to allow for any change in shape or volume of the liquid crystal material during the method. For instance, typically liquid crystal monomers shrink slightly upon polymerization, due to double bonds within the liquid crystal being reformed as single bonds. By appropriately making the optical component shaped defined by the substrate and the mould slightly oversize, an appropriately sized and shaped optical component can be produced.

Whilst the substrate has been seen in this particular example as comprising a single sheet of glass, with two flat, substantially parallel sides, it will be appreciated that the substrate can in fact be any desired shape.

An extra adhesion layer may be applied to the mould and/or substrate (prior to deposition of the bonding layer onto the substrate and the orientation layer to the mould), so as to make sure that the applied layers are well attached to the mould and the substrate. For instance, organosilanes may be used to provide this adhesion layer. For the substrate an organosilane comprising a methacrylate group may be used and for the mould an organosilane comprising an amine end group may be used.

Equally, the alignment layers used may have any desired orientation. For instance, by placing the orientation of the alignment layer on the substrate perpendicular to the orientation of the alignment layer on the mould, a twisted nematic device can be formed.

By using the above method, the predetermined shaped mould can be reused, decreasing the cost of the manufacturing process, and allowing consistently sized optical components to be produced.

1. A method of manufacturing a component comprising liquid crystal, the method comprising:
placing a liquid crystal between a substrate and a mould, the mould having a shaped surface, at least a portion of the shaped surface having an alignment layer formed thereon, and the substrate having a first surface on which is formed a bonding layer;
bringing the mould and the substrate together so as to sandwich the liquid crystal between the first surface of the substrate and the shaped surface of the mould;
polymerizing the liquid crystal;
adhering the liquid crystal to the bonding layer; and
removing the substrate with the adhered polymerized liquid crystal from the mould.

2. A method as claimed in claim 1, wherein the bonding
layer comprises at least one chemical having a covalently bonded reactive group of the same family of groups to a reactive group of the liquid crystal, such that when the liquid crystal is polymerized, the liquid crystal is adhered to the bonding layer by chemical bonds being formed between the bonding layer and the liquid crystal.

3. A method as claimed in claim 3, wherein the bonding layer comprises a chemical having a reactive group comprising at least one of acrylate, methacrylate, epoxide, oxetane, thiolene and vinylether.

4. A method as claimed in claim 1, wherein an alignment layer is formed upon the first surface of the substrate.

5. A method as claimed in claim 4, wherein a single layer is used to provide both the alignment layer on the substrate and the bonding layer.

6. A method as claimed in claim 1, wherein at least one of the substrate and/the mould are provided with an adhesion layer.

7. A method as claimed in claim 6, wherein said adhesion layer comprises an organosilane compound.

8. A method as claimed in claim 7 wherein said organosilane compound comprises a methacrylic reactive group or an amino end group.

9. A method as claimed in claim 1, wherein the substrate comprises an optically transparent material.

10. A method as claimed in claim 1, wherein the shaped surface of the mould is a curved surface, such that the substrate and the adhered liquid crystal form a lens.

11. A method as claimed in claim 1, further comprising the step of:
applying the alignment layer to the shaped surface of the mould, and inducing a specific orientation in the alignment layer.

12. An optical component comprising a liquid crystal, at least a portion of the optical component being formed according to the method as described in any one of claims 1.

13. An optical component as claimed in claim 12, wherein said optical component comprises a lens.

14. An optical scanning device for scanning an information layer of an optical record carrier, the device comprising a radiation source for generating a radiation beam and an objective system for converging the radiation beam on the information layer, wherein the device comprises an optical component formed according to the method as claimed in claim 1.

15. A device as claimed in claim 14, wherein the objective system comprises a lens formed.
